(19) United States
(12) Patent Application Publication
(10) Pub. No.: US 2007/0164559 A1
(43) Pub. Date: Jul. 19, 2007

(54) Instant lottery ticket and method

(76) Inventor: Michael Wayne Kozdras, Plant City, FL (US)

Correspondence Address: BRINKS HOFER GILSON & LIONE, P.O. BOX 10395, CHICAGO, IL, 60610, US

(21) Appl. No.: 11/334,705

(22) Filed: Jan. 17, 2006

(51) Int. Cl. B42D 15/00

(52) U.S. Cl. 283/100

(57) ABSTRACT

A method of manufacturing an improved instant lottery ticket with a graphic overprint applied by offset lithography, and the instant lottery ticket made accordingly, are provided, whereby the superior quality visual images produced by lithographic printing may be obtained for the marketing advantage of the lottery ticket. A substrate comprises a secure area having variable (e.g. game) data printed therein and a graphic area. The secure area is hidden by a non-graphic overprint layer which covers it, comprising scratch-off layers. A graphic overprint layer is applied over the non-graphic overprint layer by means of offset lithographic printing. The non-graphic overprint layer is prepared in such a manner as to provide a sufficiently thin and smooth, and having the appropriate rheology and pH characteristics, for compatibility with graphic overprinting by offset lithography.

### INDUSTRIAL FIELD

The invention relates generally to instant lottery tickets and specifically to a method of manufacturing instant lottery tickets having graphic overprints applied by offset lithography.

### BACKGROUND

Instant lottery tickets are typically comprised of a substrate having a secure area and a graphic area, with variable game data printed in the secure area and hidden by one or more opaque scratch-off layers printed there over. The colour graphical images that are printed over the scratch-off layers are commonly referred to as graphic overprints. The scratch-off layers and any other layers provided between the variable game data and the graphic overprints are commonly referred to as non-graphic overprints.

The graphic overprints of instant lottery tickets have, heretofore, typically been the least appealing visual element of the tickets because the coatings used to create opacity and scratchability in the scratch-off layers covering the variable game data have been incompatible with lithographic printing processes that produce high quality visual images. This disadvantage presents a significant problem to the instant lottery ticket industry as instant lottery tickets are impulse purchase items and the overall aesthetic appeal of an instant lottery ticket affects its marketability.

Since the inception of instant lottery tickets in the early 1970's, manufacturers have used gravure and flexographic printing processes for the application of graphic overprints because these processes use low viscosity liquid inks that can be readily applied over a wide range of surfaces including typical scratch-off layers. Although the gravure process generates a higher quality visual image than flexography, the cost of a gravure printing cylinder is comparatively high and the print quality tends to degrade unless the printing surface is smooth. Although flexography generates a comparatively poorer quality image (the flexographic printing plate being essentially a rubber stamp), flexographic plates take less time and cost to produce and are suitable for printing on irregular surfaces. Accordingly, instant lottery ticket manufacturers have almost universally adopted flexography for the overprinting of instant lottery tickets.

Innovation by manufacturers of instant lottery tickets in the United States to improve the security and performance of lottery ticket overprints has generally focussed on the formulation of the flexographic overprint coatings and inks. For example, U.S. Pat. No. 4,726,608 issued 23 Feb. 1988 concerns a tamper resistant scratch-off opaque coating, while U.S. Pat. No. 5,569,512 issued 29 Oct. 1996 concerns integrated flexographic overprinting. Although some experimentation with gravure, flexography, letterpress and silkscreen printing methodologies has been proposed (see e.g. U.S. Pat. No. 5,569,512 issued 29 Oct. 1996), no attempt has been made to seek the advantages provided by offset lithographic overprints due to the incompatibility of scratch-off print layers with the lithographic printing process.

Offset lithography provides at least the following advantages relative to other print technologies including gravure and flexography:
a more compliant final ink transfer surface that will conform to irregularities in the surface of the substrate as compared to gravure;
superior high resolution image capability as compared to letterpress, flexography and silkscreen;
higher printing speeds than flexography or silkscreen;
lower cost printing plates that can be manufactured in a very short period of time, as compared to gravure, flexography or silkscreen;
less ink volume due to the ability to carry high solid content in offset inks as compared to silkscreen, flexography or gravure;
far greater design flexibility as virtually any photographic image may be reproduced, as compared to flexography, gravure, silkscreen or letterpress;
fewer print units than are required with flexography as both high density solid areas and low density highlight areas may be printed with the same plate.

Therefore, a method of manufacturing an instant lottery ticket having a graphic overprint applied by offset lithography represents a significant advance in the art of instant lottery ticket manufacturing.

### DESCRIPTION OF AN EMBODIMENT

### a) BRIEF DESCRIPTION OF THE DRAWINGS

An understanding of the invention will be obtained from the following description of a preferred embodiment thereof, with reference to the following drawings in which:

FIG. 1 shows a pictorial view of an exemplary instant lottery ticket having a graphic overprint applied by offset lithography according to an aspect of the present invention.

FIG. 2 shows a pictorial view of a known (prior art) instant lottery ticket having a graphic overprint applied by flexography.

FIG. 3 shows a pictorial view of the main components of a typical offset lithographic printing station.

FIG. 4 shows a schematic exploded view showing the layers of the exemplary instant lottery ticket of FIG. 1.

FIG. 5 shows a pictorial view of the main components of a typical flexographic printing station.

FIG. 6 shows a schematic view of the separate print layers of the exemplary instant lottery illustrated in FIGS. 1 and 4.

Where appropriate, identical reference numerals have been used to designate like elements in the figures.

### DESCRIPTION

The invention claimed herein provides a method of manufacturing an instant lottery ticket with a graphic overprint applied by offset lithography and the instant lottery ticket made accordingly. Although the relative advantages of offset lithography are many, its use for graphic overprinting of instant lottery tickets has heretofore not been successfully used. The inventor has identified a number of obstacles which must be overcome in order to do so, including a requirement of a smoother printing surface relative to flexography, the high tack of the offset inks which tend to pick the non-graphic overprint and the pH control requirements of the offset dampening solution. Moreover, the inventor has overcome these obstacles by providing a ticket surface, including the surface over the scratch-off layers, which is compatible with offset lithographic printing, thus enabling the printing of an integrated graphic overprint over the entire surface of the ticket.

In accordance with one aspect of the invention, there is provided herein a method of manufacturing an improved instant lottery ticket having a graphic overprint applied by offset lithography. The method comprises applying variable game data in a secure area of a substrate, applying a non-graphic overprint over the variable game data and applying a graphic overprint over a print surface of the non-graphic overprint by offset lithography. The non-graphic overprint has an opaque scratch-off layer and is composed of non-graphic overprint materials. The non-graphic overprint materials render the print surface compatible with offset lithography and resistant to the removal of pH-altering elements therefrom by the application of the graphic overprint. The non-graphic overprint has a thinness and a smoothness, and is sufficiently thin and smooth to resist tacking caused by the application of the graphic overprint.

In accordance with another aspect of the present invention, there is provided herein an improved instant lottery ticket having a graphic overprint applied by offset lithography. The ticket comprises variable game data in a secure area of a substrate, a non-graphic overprint over the variable game data and a graphic overprint applied by offset lithography over a print surface of the non-graphic overprint. The non-graphic overprint has an opaque scratch-off layer and is composed of non-graphic overprint materials. The non-graphic overprint materials and the non-graphic overprint are compatible with offset lithographic printing thereover.

In accordance with a further aspect of the invention, there is provided herein a method of manufacturing an improved instant lottery white ticket suitable for the application thereon of a graphic overprint by offset lithography. The method comprises applying variable game data in a secure area of a substrate and applying a non-graphic overprint over the variable game data. The non-graphic overprint has an opaque scratch-off layer and a print surface, and is composed of non-graphic overprint materials. The non-graphic overprint materials render the print surface compatible with offset lithography and resistant to the removal of pH-altering elements therefrom by the application of the graphic overprint. The non-graphic overprint has a thinness and a smoothness, and is sufficiently thin and smooth to resist tacking caused by the application of the graphic overprint.

In accordance with a further aspect of the invention, there is provided herein an improved instant lottery white ticket suitable for the application thereon of a graphic overprint by offset lithography. The white ticket comprises variable game data in a secure area of a substrate and a non-graphic overprint over the variable game data. The non-graphic overprint has a print surface and an opaque scratch-off layer, and is composed of non-graphic overprint materials. The print surface is configured to receive the graphic overprint. The non-graphic overprint materials render the print surface compatible with offset lithography and resistant to the removal of pH-altering elements therefrom by the application of the graphic overprint. The non-graphic overprint has a thinness and a smoothness, and is sufficiently thin and smooth to resist tacking caused by the application of the graphic overprint.

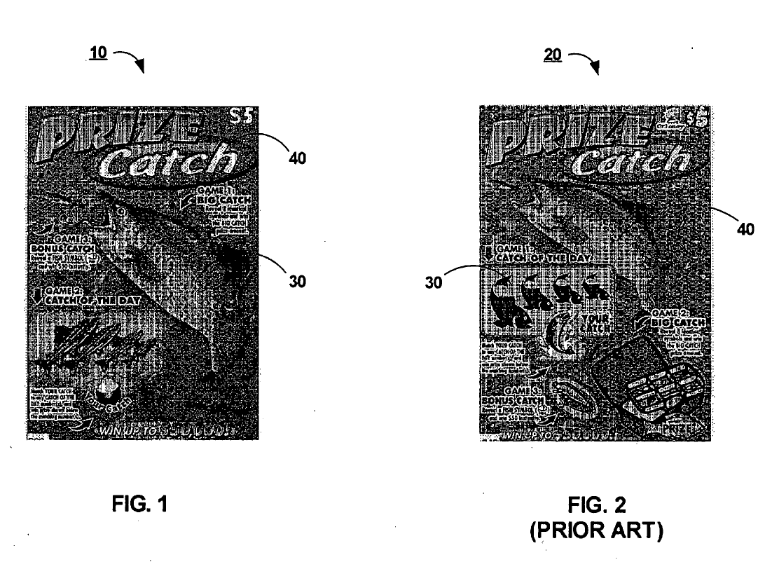

An exemplary instant lottery ticket 10 with a graphic overprint applied by offset lithography manufactured is shown in FIG. 1. For comparative purposes, a prior art instant lottery ticket 20 with a graphic overprint applied by flexography is shown in FIG. 2. Each of the tickets has a secure area 30 covered by a number of scratch-off layers and a graphic area 40. As may be readily appreciated by a comparison of the two tickets, the exemplary ticket 10 presents a visual impression that is far superior to that of the prior art ticket 20, including in the secure area 30.

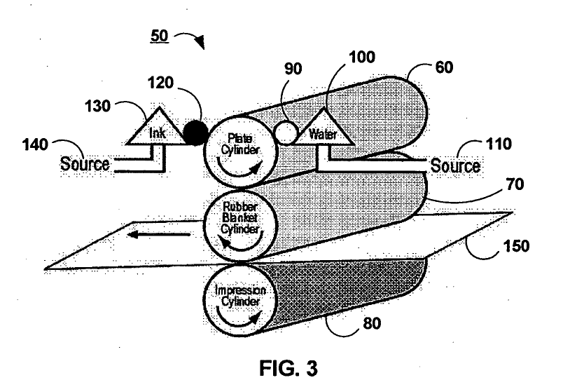

A description of the offset lithographic printing process and of the above-mentioned obstacles follows with reference to FIG. 3 which depicts an offset lithographic printing station 50. In offset lithographic printing, each printing station 50 includes a plate cylinder 60 containing the desired image, a rubber blanket cylinder 70 and an impression cylinder 80. As the plate cylinder 60 turns, it is dampened by a wetted roller 90 which is wetted with dampening solution (principally composed of water) by a dampening solution applicator 100 from a dampening solution source 110. The dampening solution ideally only wets non-image portions of the plate cylinder 60. Ink is then applied to the plate cylinder 60 by an ink roller 120 inked by an ink applicator 130 with oil-based ink from an ink source 140. As the oil-based ink and dampening solution (primarily water) normally do not mix, the ink only adheres to image areas of the plate cylinder 60. Lithographic printing is enabled by the fact that the image areas of the lithographic plate are oleophilic and the non-image areas of the plate are hydrophilic. The plate cylinder 60 then comes into contact with the rubber-blanketed cylinder 70 circumferentially reversing and transferring, or “offsetting”, the right-reading plate image to the rubber blanket cylinder 70. The rubber blanket cylinder 70, in turn, transfers the image to the substrate 150 against an impression cylinder 80 creating a positive, right-reading image.

The obstacles to using offset lithography for graphic overprinting of a surface comprising scratch-off print layers are three-fold. Firstly, while the rubber blanket cylinder 70 is typically more flexible than a gravure cylinder, they are typically less flexible than flexographic plates. Consequently, to obtain a high-quality image, offset lithography requires a print surface that is smoother than that tolerated by flexography. Prior art non-graphic overprints are used in combination with flexographically printed graphic overprints and are not configured for a high-quality offset lithographic overprint. Furthermore, it is desirable to be able to print both the secure area (over the non-graphic overprint) and the graphic area with a graphic overprint in one step using offset lithography. For example, U.S. Pat. No. 5,569,512 describes such a process employing flexography. However, typical non-graphic overprints (i.e. printed over scratch-off layers) are relatively thick whereby the print surface is excessively elevated above the substrate frustrating the application of a graphic overprint across the entire surface of the ticket by offset lithography.

Secondly, offset lithography employs inks that are highly viscous, with high tack and with a high shear characteristic as compared to the relatively thinner, liquid inks employed in gravure or flexography. Accordingly, offset lithography has a greater tendency than gravure or flexography to “pull” on the print surface during the printing process causing picking and damage to the layers of prior art non-graphic overprints. This occurs most readily where the surface is not smooth or where it presents an edge, a bump or a sharp change in elevation relative to the substrate. Accordingly, a relatively smooth print surface, having a relatively low elevation over the substrate, is required in order to minimize such steps or edge.

Thirdly, as described above, the offset lithographic process relies upon the fact that the dampening solution and the inks properly adhere to respective areas of the plate cylinder 60 and do not mix. However, this requires that the pH of the dampening solution be maintained within certain limits. Although it is not ideal, it is typical that a very small amount of the dampening solution is transferred during the printing process to the rubber blanket cylinder 70 and thence to the substrate 150. Likewise, although it is not ideal, it is typical that a very small amount of the surface components of the substrate 150 are carried away by the rubber blanket cylinder 70, then passed on to the plate cylinder 60, and thereafter further passed to the dampening solution source 110. If this back-transfer of substrate components excessively alters the pH of the dampening solution, the performance of the printing process suffers.

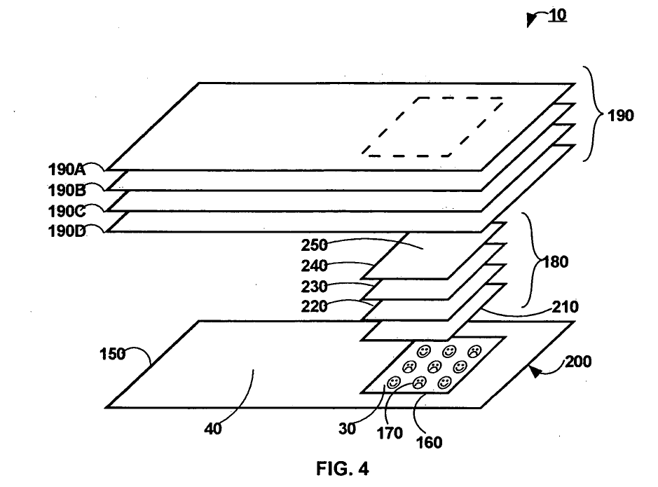

FIG. 4 shows the print layers of an exemplary instant lottery ticket 10 which has been manufactured by the method described hereinafter to overcome these obstacles. The ticket comprises a substrate 150 having a secure area 30 and a graphic area 40. The substrate 150 is typically composed of paper, cardstock, or foil laminated cardstock, but may also be composed of unconventional materials such as holographic papers or films, and polymers such as polyester, polyethylene and Mylar®. The secure area 30 is preferably prepared with a base layer 160. The ticket 10 further comprises variable game data 170 applied over the base layer 160, a non-graphic overprint 180 (in this example being made up of scratch-off layers 210, 220, 230, and 240, as shown) applied over the variable game data 170, and a graphic overprint 190 (in this example being made up of layers 190A-D, as shown) applied over the non-graphic overprint 180 and, preferably, also the graphic area 40 of the substrate 150. Thus, the secure area 30 of the completed ticket 10 is hidden by the non-graphic overprint 180 covering it, but may be uncovered by a player to reveal the variable game data 170, by scratching off those opaque layers covering the variable game data 170, for example by using a fingernail or an instrument such as a coin. It is such uncovering of the variable game data 170 that permits the game to be played.

An instant lottery ticket 10 is manufactured by application of the variable game data 170, the non-graphic overprint 180 and the graphic overprint 190 to the substrate 150, wherein the graphic overprint 190 is applied by offset lithography. In the illustrated embodiment, the layers depicted in FIG. 4 are applied successively to the substrate 150 as described below. However, it is to be understood that all layers described herein, as being a single layer, may instead comprise a plurality of sub-layers. The choice of such specifics, in terms of the number of sub-layer prints to be used for a given application, is wholly within the normal choices to be made by one skilled in the art. Furthermore, for a given application, the user may choose to use one or more additional layers to those of the exemplary embodiment described herein.

With reference to FIG. 4, the ticket 10 preferably has a base layer 160 covering the substrate 150 at least in the secure area 30 of the ticket 10. The base layer 160 may be a separate layer applied to the substrate 150 or may be integral with the substrate 150. The base layer 160 may be applied by the instant ticket manufacturer or the substrate vendor, the latter being the case with some security papers or foil-laminated substrates. As is well known in the lottery ticket printing art, the base layer 160 is formulated and applied so as to create resistance to known optical, magnetic, chemical, physical, electrical and other forms of security compromise techniques and to provide a surface suitable for receiving the variable game data 170. It may include metals such as aluminum, copper, iron oxide, carbon black, titanium dioxide, water soluble or solvent soluble dyes or inks, and a wide range of resins. It is typically applied by flexography but may alternatively be applied by any suitable printing technology and, as stated, may be pre-applied to a substrate when purchased. The base layer 160 may also comprise graphic images in the graphic area 40 of the ticket comprising water based, solvent based, radiation cured processes or PMS coloured inks or coatings. Such images may be applied using all known forms of print technology including offset lithography, flexography, gravure, letterpress and digital printing. The substrate 150 preferably has non-secure information printed on its reverse which may be termed variable back data 200.

The variable game data 170 comprises the game indicia common to all instant lottery tickets. The most widely accepted method for printing the variable game data is water-based inkjet, however solvent-based inkjets, toner-based imagers or any other suitable printing technology may also be used for this purpose.

A seal layer 210 provides a barrier to seal and protect the variable game data 170. A release layer 220 provides a layer from which a scratch-off layer 230, which covers the release layer 220, may be easily removed by scratching. While the seal layer 210 and the release layer 220 typically comprise more than one layer, they may comprise a single or multiple layers that may be tinted, transparent, translucent or clear. These layers guard against physical, thermal, or chemical tampering and are well known in the lottery ticket printing art. They may be solvent based or water based, which are dried using combinations of heat energy and air turbulence, or designed so as to be cured using various forms of radiation such as electron beam or ultraviolet radiation. As such, the well known chemical formulations of the materials vary widely and may include vinyl chloride resins, polyamide resins, silicone, monomers, oligomers, waxes, benzophenone, anti-foaming agents, photo-initiators and colourants.

The scratch-off layer 230, the characteristics and composition of which are also well known in the art, is typically an elastomeric layer comprising a dark-coloured latex that provides the necessary opacity and elastic properties to cover and hide the variable data yet be sufficiently removable through the process of scratching. This layer may contain several pigments dispersed in solvent based, water based or energy curable bases, and typically contains synthetic rubbers, and metals such as aluminum, copper, bronze, carbon black, graphite, or any other materials that create the necessary opaque elastomeric characteristic of a scratch-off coating. This layer may be used to absorb solvents and resist many known forms of decoding including electrostatic, X-ray, chemical, thermal, adhesive, vapour and a wide range of physical forms of attack such as lifting, pinpricking and the like.

A preparatory surface layer 240, applied over the scratch-off layer 230, comprises layers designed to shift the dark colour of the scratch-off layer 230 to one more suitable for graphic application, typically a white or off-white surface. These layers may also add opacity and/or some of security characteristics of the previous layers, including solvent sensitivity and chemical barriers. Advantageously, the materials of the preparatory surface layer 240 are selected in such a manner as to provide a print surface 250 suitable for offset lithographic overprinting.

All of the foregoing layers of the non-graphic overprint 180 may be applied to the substrate 150 by any suitable printing technology including offset lithography, flexography and gravure or a combination thereof, and preferably by flexography.

The graphic overprint 190 comprises at least one layer, but preferably a multiplicity of layers 190A-190D of ink providing any chosen images on the secure area of the ticket, and in particular on the print surface 250 of the preparatory surface layer 240. The technology of offset lithography, including the composition of offset lithographic inks and their sources of supply, are well known in the art. A graphic overprint 190 may be applied to only the secure area 30 or, alternatively, to both the secure area 30 and the graphic area 40 in a single offset lithographic printing process.

The obstacles to offset lithography described earlier are overcome by making the non-graphic overprint 180 sufficiently smooth and thin, and sufficiently strong to resist picking from the high tack of the offset inks, so as to provide a print surface 250 which is compatible with offset lithography, and without altering the dampening solution pH to such a degree that this compatibility becomes nullified during the course of the ticket printing process. Persons skilled in the art are able to realize each of these criteria successfully based on the description herein and appropriate selection of materials determined in part by whatever is chosen for the particular implementation of the offset lithographic printing process. A general description of flexographic printing is provided hereinafter, to provide the context in which the described criteria are to be realized, in this example, when applying the above-described layers of the non-graphic overprint 180.

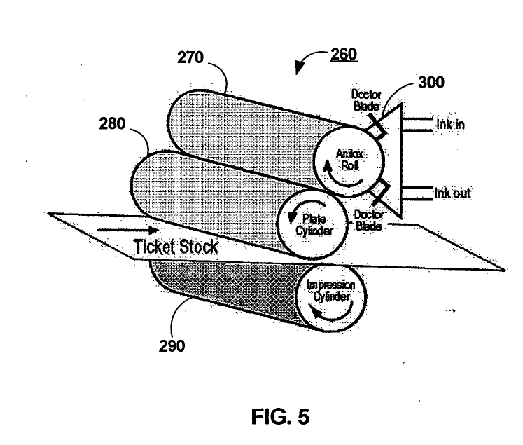

FIG. 5 depicts the main components of a typical flexographic printing station 260. It includes an anilox roll 270, a plate cylinder 280 and an impression cylinder 290. The anilox roll 270 supplies a controlled film of ink to the plate cylinder 280. As mentioned earlier, the flexographic plate cylinder 280 is essentially a rubber stamp. Along the anilox roll 270 is a chambered “doctor blade” 300 incorporating reverse and normal angled blades. The doctor blade 300 meters ink and removes excess surface ink from the anilox roll 270 in order to ensure a more controlled inking of the plate cylinder 280.

As will be readily understood by one skilled in the art, the configuration of the anilox roll 270 and doctor blade 300 may be appropriately chosen so as to provide a layer of any desired thickness. Furthermore, the material used for any layer may be appropriately chosen so as to provide a layer with any desired characteristics including rheology. The inks used for the various layers included in the scratch-off layer 230 and the preparatory surface layer 240 (each preferably comprising a plurality of layers) are chosen to achieve the required smoothness of the print surface 250. For example, in one embodiment, the inks for each layer are chosen to have a progressively lower viscosity and are applied in progressively thinner layers.

In addition, to allow a non-graphic overprint 180 that is as thin as possible, it is preferable to adapt other parts of the ticket 10 to accomplish one or more of the desired functions of the non-graphic overprint 180. For example, the base layer 160 may be constructed so as to be substantially opaque thereby reducing the need for a thicker non-graphic overprint 180 but still providing sufficient opacity to safeguard against security compromise techniques such as candling. Selecting and constructing the base layer 160 or any other layer below the scratch-off layer 230 to have a greater opacity may, however, result in an increased thickness in those layers. To compensate for any added thickness, a further improvement to the uniformity of the thickness of the non-graphic overprint may be obtained by calendaring (a process of levelling) the construction of the non-graphic overprint prior to the application of the scratch-off layer resulting in a further improvement to the print surface. Furthermore, this process is improved by using lower cost, low density substrates further reducing the overall cost of manufacturing and enhancing the security of the ticket, particularly against abrasion resistance.

The rheology and chemistry of the ink(s) used for the preparatory surface layer 240 is (are) selected to provide a print surface 250 that is compatible with the graphic overprint layer 190 applied there over by offset lithographic printing. More specifically, these inks are selected to satisfy the criteria that any back-transfer of elements of a type to cause alteration of the pH of the offset dampening solution, will be of a limited quantity only, so as to ensure that this compatibility does not become nullified during the course of the ticket printing process.

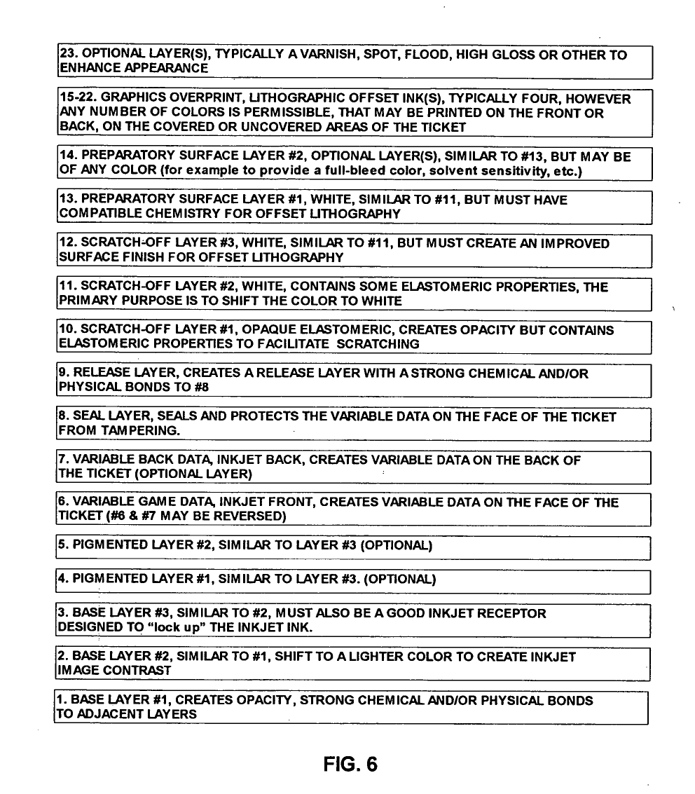

FIG. 6 shows a schematic view of the print layers as applied to a ticket according to FIG. 4. In this example, the layers, numbered layers 1-23, are depicted from bottom to top as they are applied to the substrate 150. Each of the depicted layers is applied by flexography unless otherwise indicated. Table 1, below, indicates the composition of the layers shown in FIG. 6, wherein the layer numbers indicated in Table 1 and FIG. 6 correspond.

TABLE 1

| Layer # | Layer Name | Composition |
|---|---|---|
| 1 | Base Layer #1 | 20-60% black pigment in a resin |
| | (Dark Base Coat) | binder, with a pH range of 7-10, |
| | | viscosity range of 50-500 cps |
| 2 | Base Layer #2 | 20-60% black pigment in a resin |
| | (Intermediate Base | binder, with a pH range of 7-10, |
| | Coat) | 50-500 cps |
| 3 | Base Layer #3 | 20-60% black pigment in a resin |
| | (Light Base Coat) | binder, with a pH range of 7-10, |
| | | 50-500 cps |
| 4 | Pigmented Base Coat | 20-60% black pigment in a resin |
| | #1 (Optional) | binder, with a pH range of 7-10, |
| | | 50-500 cps |
| 5 | Pigmented Base Coat | 20-60% black pigment in a resin |
| | #2 (Optional) | binder, with a pH range of 7-10, |
| | | 50-500 cps |
| 6 | Variable Game Data | Water Miscible Dye Based Ink, |
| | (Inkjet) | viscosity range of 1-5 cps |
| 7 | Variable Back Data | Water Miscible Dye Based Ink, |
| | (Inkjet) (Optional) | viscosity range of 1-5 cps |
| 8 | Seal Layer | Evaporative or Energy Curable Water |
| | | Resistant Adhesive, viscosity of |
| | | 50-500 cps |
| 9 | Release Layer | Evaporative or Energy Curable |
| | | Solvent Resistant, High Gloss, |
| | | High Slip, Low Surface Energy, |
| | | Overprint Coating, viscosity of |
| | | 50-500 cps |
| 10 | Scratch-Off Layer #1 | Evaporative or Energy Curable |
| | (Dark Elastomeric) | Opaque Elastomeric Coating |
| 11 | Scratch-Off Layer #2 | Evaporative or Energy Curable |
| | (Light Colored | Opaque Elastomeric |
| | Elastomeric, normally | |
| | white) (Optional) | |
| 12 | Scratch-Off Layer #3 | An opaque white coating with |
| | (White Overprint) | strong affinity for adjacent |
| | | coatings, and broad solvent |
| | | sensitivity |
| 13 | Preparatory Surface | An opaque white coating with |
| | Layer #1 (Optional) | strong affinity for adjacent |
| | (White Overprint) | coatings, with solvent |
| | | sensitivity, good leveling, |
| | | and compatibility with offset |
| | | ink |
| 14 | Preparatory Surface | An opaque coating with strong |
| | Layer #2 (Optional) | affinity for adjacent coatings, |
| | (White or Pigmented | with solvent sensitivity, good |
| | Overprint) | leveling, and compatibility |
| | | with offset ink |
| 15 | Offset Ink 1 | High viscosity, 10,000 to 80,000 |
| | | cps, conventional or radiation |
| | | cured inks |
| 16 | Offset Ink 2 | High viscosity, 10,000 to 80,000 |
| | | cps, conventional or radiation |
| | | cured inks |
| 17 | Offset Ink 3 | High viscosity, 10,000 to 80,000 |
| | | cps, conventional or radiation |
| | | cured inks |
| 18 | Offset Ink 4 | High viscosity, 10,000 to 80,000 |
| | | cps, conventional or radiation |
| | | cured inks |
| 19 | Offset Ink 5 (optional) | High viscosity, 10,000 to 80,000 |
| | | cps, conventional or radiation |
| | | cured inks |
| 20 | Offset Ink 6 (optional) | High viscosity, 10,000 to 80,000 |
| | | cps, conventional or radiation |
| | | cured inks |
| 21 | Offset Ink 7 (optional) | High viscosity, 10,000 to 80,000 |
| | | cps, conventional or radiation |
| | | cured inks |
| 22 | Offset Ink 8 (optional) | High viscosity, 10,000 to 80,000 |
| | | cps, conventional or radiation |
| | | cured inks |
| 23 | Overprint Varnish | High Gloss overprint varnish, |
| | (optional) | viscosity of 50-500 cps. |

By way of example, the materials (inks) of the scratch-off layers may be the following:
Scratch-off Layer #1—high pigment titanium dioxide formulated, water based aqueous coating, with a viscosity of 500 to 1,000 cps, pH range of 7 to 10, such as Sun Chemical AQ HI-OPAQ White CGI 20120;
Scratch-off Layer #2—high pigment titanium dioxide formulated, water based aqueous coating, with improved ink holdout as a result of microcrystalline wax addition, in a viscosity of 500 to 1,000 cps, pH range of 7-10, such as Sun Chemical WB 2nd DN White CGI 20121;
Scratch-off Layer #3—similar to scratch-off layer #2.

The above-indicated materials are selected in order to provide a non-graphic overprint layer 180 that is sufficiently smooth and that provides a print surface with the correct rheology and pH characteristic for graphic overprinting by offset lithography without unduly adversely altering the pH of the dampening solution.

To print the individual layers (sub-layers) of the non-graphic overprint layer 180, using flexography, a specially configured anilox roll 270, for appropriate metering of the inks applied by it, is used. This is done to address the objective that these layers be applied so as to result in a thin and smooth print surface 250. Specifically, channelled anilox rolls 270 (available, for example from Harper Graphic Solutions), configured as follows, are used by the flexographic printing stations which print the three scratch-off layers:
For scratch-off Layer #1—85 line/inch, 19 billion cubic micron, 30 degree engraving angle;
For scratch-off Layer #2—100 line/inch, 15 billion cubic micron, 30 degree engraving angle; and
For scratch-off Layer #3—120 line/inch, 11 billion cubic micron, 30 degree engraving angle.

As will be understood by persons skilled in the art, the use of such progressively decreasing cell size of the engraved anilox roller provides increasingly uniform coverage so that any discontinuities (i.e. gaps) resulting from the larger cells and the coarser layer(s) are subsequently filled in (i.e. smoothed out) so that the surface 250 is smooth once the final layer has been applied.

A print surface prepared as described above is suitable for graphic overprinting by offset lithography. Furthermore, it is suitable for the application of graphic overprint layers by offset lithography in combination with the application of such layers by any other suitable print technology including flexography, gravure, letterpress, inkjet or digital printing.

Prior to the application of a graphic overprint, a ticket produced according to the methods disclosed herein constitutes a “White ticket” suitable for graphic overprinting by offset lithography. These white tickets could then be supplied to purchasers who themselves apply the graphic overprint. In this way, a purchaser would need only the graphic overprinting equipment and not the equipment required for the production of the white ticket. Accordingly, any number of purchasers of white tickets could apply their own customized graphic overprints while the capital equipment costs of producing the white tickets would be advantageously centralized in a white ticket manufacturer.

With the foregoing exemplary embodiment of the invention having been disclosed, it will be apparent to those skilled in the art that various changes and modifications can be made, to appropriately suit the needs and objectives of another application and still achieve the advantages of the invention, all of which are intended to fall within the scope of the invention as defined by the claims that follow.

What is claimed is:

1. A method of manufacturing an improved instant lottery ticket having a graphic overprint applied by offset lithography, the method comprising:
a) applying variable game data in a secure area of a substrate;
b) applying a non-graphic overprint over the variable game data, the non-graphic overprint comprising an opaque scratch-off layer and having a thinness, a smoothness and a print surface, the non-graphic overprint being composed of non-graphic overprint materials; and,
c) applying a graphic overprint over the print surface by offset lithography;
wherein the non-graphic overprint materials render the print surface compatible with offset lithography and resistant to the removal of pH-altering elements therefrom by the application of the graphic overprint; and,
wherein the non-graphic overprint is sufficiently thin and smooth to resist tacking caused by the application of the graphic overprint.

2. The method according to claim 1, wherein the non-graphic overprint is applied by any of offset lithography, flexography or gravure.

3. The method according to claim 2, wherein the thinness and/or smoothness of the non-graphic overprint is at least in part controlled by a channel configuration of a plurality of anilox rollers in the application of the non-graphic overprint by flexography.

4. The method according to claim 3, wherein the smoothness of the print surface is at least in part determined by viscosities of the non-graphic overprint materials and the configuration of one or both of the anilox rollers and doctor blades.

5. The method according to claim 1, wherein the graphic overprint is further applied over at least a part of a graphic area of the substrate.

6. The method according to claim 1, wherein the substrate is composed of one of paper, cardstock, foil-laminated cardstock, holographic papers or films, polyester, polyethylene or Mylar®.

7. The method according to claim 1 further comprising printing information on a reverse side of the substrate.

8. The method according to claim 1 further comprising applying a base layer between the substrate and the variable game data.

9. The method according to claim 8, wherein the base layer is substantially opaque.

10. The method according to claim 8, wherein the base layer is applied by flexography.

11. The method according to claim 8, wherein the base layer comprises graphic images in a graphic area of the substrate.

12. The method according to claim 11, wherein the base layer is applied by any of offset lithography, flexography, gravure, letterpress and digital printing.

13. The method according to claim 1, wherein the substrate has a base layer integral with the substrate.

14. The method according to claim 1, wherein the variable game data is applied by any of water-based inkjet, solvent-based inkjet or toner-based imaging.

15. The method according to claim 1, wherein the non-graphic overprint comprises a seal layer covering the variable game data, a release layer covering the seal layer, and the scratch-off layer covering the release layer.

16. The method according to claim 15, wherein the seal layer is composed of a seal layer material, and wherein the release layer is composed of a release layer material, and wherein the seal layer material and release layer material may each be comprised of any of vinyl chloride resins, polyamide resins, silicone, monomers, oligomers, waxes, benzophenone, anti-foaming agents, photo-initiators and colourants.

17. The method according to claim 16, wherein the scratch-off layer is composed of a scratch-off layer material comprising any of latex, pigments, synthetic rubbers, aluminum, copper, bronze, carbon black and graphite.

18. The method according to claim 17, wherein the scratch-off layer comprises a plurality of scratch-off sub-layers.

19. The method according to claim 18, wherein each of the plurality of scratch-off sub-layers is composed of a scratch-off sub-layer material, wherein each scratch-off sub-layer material has a viscosity, the plurality of scratch-off sub-layer materials having a range of viscosities.

20. The method according to claim 15, wherein the non-graphic overprint further comprises a preparatory surface layer covering the scratch-off layer.

21. The method according to claim 20, wherein the preparatory surface layer comprises a plurality of layers.

22. The method according to claim 1 further comprising applying at least one further graphic overprint over the print surface by a suitable print technology.

23. The method according to claim 22 wherein the suitable print technology is any of flexography, gravure, letterpress, inkjet and digital printing.

24. An improved instant lottery ticket manufactured according to the method of claim 1.

25. An improved instant lottery ticket comprising:
a) a substrate having a secure area;
b) variable game data printed in the secure area;
c) a non-graphic overprint covering the variable game data; and
d) a graphic overprint covering the non-graphic overprint, the graphic overprint comprising offset lithographic inks and applied by offset lithography.

26. An improved instant lottery ticket having a graphic overprint applied by offset lithography, comprising:
a) variable game data in a secure area of a substrate;
b) a non-graphic overprint over the variable game data, the non-graphic overprint comprising an opaque scratch-off layer and composed of non-graphic overprint materials; and,
c) a graphic overprint applied by offset lithography over a print surface of the non-graphic overprint;
wherein the non-graphic overprint materials and the non-graphic overprint are compatible with offset lithographic printing thereover.

27. A method of manufacturing an improved instant lottery white ticket suitable for the application thereon of a graphic overprint by offset lithography, the method comprising:
a) applying variable game data in a secure area of a substrate; and
b) applying a non-graphic overprint over the variable game data, the non-graphic overprint comprising an opaque scratch-off layer and having a thinness, a smoothness and a print surface, the print surface being configured to receive the graphic overprint, the non-graphic overprint being composed of non-graphic overprint materials;
wherein the non-graphic overprint materials render the print surface compatible with offset lithography and resistant to the removal of pH-altering elements therefrom by the application of the graphic overprint; and,
wherein the non-graphic overprint is sufficiently thin and smooth to resist tacking caused by the application of the graphic overprint.

28. An improved instant lottery white ticket suitable for the application thereon of a graphic overprint by offset lithography, the white ticket comprising:
a) variable game data in a secure area of a substrate;
b) a non-graphic overprint over the variable game data, the non-graphic overprint comprising an opaque scratch-off layer and having a thinness, a smoothness and a print surface, the print surface being configured to receive the graphic overprint, the non-graphic overprint being composed of non-graphic overprint materials;
wherein the non-graphic overprint materials render the print surface compatible with offset lithography and resistant to the removal of pH-altering elements therefrom by the application of the graphic overprint; and,
wherein the non-graphic overprint is sufficiently thin and smooth to resist tacking caused by the application of the graphic overprint.
